(19) United States
(12) Patent Application Publication
(10) Pub. No.: US 2025/0171003 A1
(43) Pub. Date: May 29, 2025

(54) BRAKING APPARATUS FOR VEHICLE

(71) Applicant: HYUNDAI MOBIS CO., LTD., Seoul (KR)

(72) Inventors: Sung Ki AHN, Yongin-si (KR); Jeong Hoon BAE, Yongin-si (KR)

(73) Assignee: HYUNDAI MOBIS CO., LTD., Seoul (KR)

(21) Appl. No.: 18/806,092

(22) Filed: Aug. 15, 2024

(30) Foreign Application Priority Data
Nov. 29, 2023 (KR) 10-2023-0169421

(51) Int. Cl. B60T 13/14; B60T 15/36; B60T 17/04; F16K 15/02; F16K 15/04

(52) U.S. Cl. CPC B60T 13/148; B60T 13/142; B60T 15/36; B60T 17/04; F16K 15/025; F16K 15/044; F16K 2200/401

(57) ABSTRACT

A braking apparatus includes a pedal part pressurized for braking by a driver, a master cylinder part in which pressure of oil is amplified by the pedal part, a block part connected to the master cylinder part, supplied with the oil, and configured to amplify the pressure of the oil as an electric pump is driven by power applied thereto, a wheel cylinder part connected to the block part and configured to provide a braking force to a wheel, and a variable valve part mounted on the block part and configured to adjust the flow amount of oil based on a flow rate of the oil that is discharged by the electric pump.

### CROSS-REFERENCE TO RELATED APPLICATION

This application claims priority from and the benefit of Korean Patent Application No. 10-2023-0169421, filed on Nov. 29, 2023, which is hereby incorporated by reference for all purposes as if set forth herein.

### BACKGROUND

### Field

Exemplary embodiments of the present disclosure relate to a braking apparatus for a vehicle, and more particularly, to a braking apparatus for a vehicle, which can prevent a loss attributable to increased pressure by adjusting a flow channel according to a flow rate and suppress the occurrence of pulsation noise.

### Discussion of the Background

In general, an electric hydraulic brake system adjusts braking pressure of each wheel by fluid pressure of a master cylinder that is driven by a motor after a driver's pedal pressure is sensed through a sensor.

The electric hydraulic brake system includes the sensor for sensing the stroke distance of a pedal so that a driver can be aware of desired braking pressure.

Furthermore, the electric hydraulic brake system includes a pedal travel simulator that enables a driver to feel the same pedal pressure as in a common hydraulic brake apparatus.

Accordingly, when the driver steps on the brake pedal, an electronic control unit supplies fluid pressure to the master cylinder by sensing the stepping of the brake pedal.

Furthermore, the master cylinder provides a braking force to each wheel by transmitting braking fluid pressure to the wheel cylinder of each wheel.

A conventional electric hydraulic brake system has a problem in that it is difficult to increase pressure or a pulsation phenomenon is caused because a flow channel for braking does not actively handle braking fluid pressure according to revolution per minute (RPM) of a motor. Accordingly, there is a need to solve the problem.

The Background Technology of the present disclosure is disclosed in Korean Patent Application Publication No. 2007-0104982 (Oct. 30, 2007) entitled “Control Apparatus For Valve In Electro- Hydraulic Brake System”.

### SUMMARY

Various embodiments are directed to providing a braking apparatus for a vehicle, which can prevent a loss attributable to increased pressure by adjusting a flow channel according to a flow rate and suppress the occurrence of pulsation noise.

In an embodiment, a braking apparatus for a vehicle may include a pedal part pressurized for braking by a driver, a master cylinder part in which pressure of oil is amplified by the pedal part, a block part connected to the master cylinder part, supplied with the oil, and configured to amplify the pressure of the oil as an electric pump is driven by power applied thereto, a wheel cylinder part connected to the block part and configured to provide a braking force to a wheel, and a variable valve part mounted on the block part and configured to adjust the flow amount of oil based on a flow rate of the oil that is discharged by the electric pump.

The block part may include a pump flow channel configured to provide the oil that is discharged by the electric pump with guidance, a wheel flow channel connected to the wheel cylinder part, and a valve flow channel configured to connect the pump flow channel and the wheel flow channel, wherein the variable valve part may be mounted on the valve flow channel.

The variable valve part may include an internal valve part configured to transmit oil through a central part thereof, an external valve part surrounding the internal valve part and to transmit oil toward an inside thereof through a hole formed at a central part of external valve part, a cover valve part coupled to the external valve part and configured to transmit oil, and an adjustment valve part mounted between the internal valve part and the cover valve part and configured to adjust a passage of oil by elastically supporting the internal valve part.

The internal valve part may include an internal inlet part disposed within the external valve part and configured to transmit the oil discharged by the electric pump through the first hole, an internal open and close part extended from the internal inlet part and including an internal hole connected to the first hole, and configured to transmit oil between the internal valve part and the external valve when an outside of the internal open and close part does not come into contact with the external valve part or to block a movement of oil between the internal valve part and the external valve part when an outside of the internal open and close part comes into contact with the external valve part, and an internal expansion part extended from the internal open and close part and configured to transmit oil through the internal hole of the internal expansion part.

The external valve part may include an outside support part including the second hole and spaced from the internal inlet part, and configured to selectively contact to the internal open and close part and an outside duct part extended from the outside support part and surrounding the internal expansion part, wherein a flow passage of the oil is formed between the second hole of the outside support part and the first hole of the internal open and close part.

The cover valve part may include a cover coupling part connected to the outside duct part and a cover extension part extended from the cover coupling part and including the third hole through which the oil is transmitted.

The adjustment valve part may include an adjustment elastic part disposed between the cover extension part and the internal expansion part and configured to elastically support the internal expansion part toward the internal valve part.

The adjustment valve part further may include an adjustment ball part mounted between the internal valve part and the cover valve part and configured to open or close a flow channel of oil between the first hole of the internal valve part and the third hole of the cover valve part by being moved by pressure of the oil within the internal open and close part.

The adjustment ball part may be closely attached to a second internal hole that is formed within the internal open and close part, and prevents a countercurrent of the oil.

In an embodiment, a braking apparatus for a vehicle may include an internal valve part configured to transmit oil toward a central part of the internal valve part, an external valve part surrounding the internal valve part and to transmit oil toward an inside thereof through a hole formed at a central part of external valve part, a cover valve part coupled to the external valve part and configured to transmit oil, and an adjustment valve part mounted between the internal valve part and the cover valve part and configured to adjust a passage of oil by elastically supporting the internal valve part.

The braking apparatus for a vehicle according to an embodiment of the present disclosure can reduce pressure pulsation amplitude because the passage of oil varies depending on a flow rate.

### BRIEF DESCRIPTION OF THE DRAWINGS

FIG. 1 is a diagram schematically illustrating a braking apparatus for a vehicle according to an embodiment of the present disclosure.

FIG. 2 is a diagram schematically illustrating a block part according to an embodiment of the present disclosure.

FIG. 3 is a combined cross-sectional view schematically illustrating a variable valve part according to an embodiment of the present disclosure.

FIG. 4 is an exploded cross-sectional view schematically illustrating a variable valve part according to an embodiment of the present disclosure.

FIG. 5 is a diagram schematically illustrating the state in which a small amount of oil passes through the variable valve part according to an embodiment of the present disclosure.

FIG. 6 is a diagram schematically illustrating the state in which a large amount of oil passes through the variable valve part according to an embodiment of the present disclosure.

FIG. 7 is a diagram schematically illustrating the state in which the countercurrent of oil through the variable valve part according to an embodiment of the present disclosure is prevented.

FIG. 8 is a graph schematically illustrating a pressure change depending on whether the variable valve part according to an embodiment of the present disclosure is present or not when an electric pump is in a low RPM driving area.

FIG. 9 is a graph schematically illustrating a pressure change depending on whether the variable valve part according to an embodiment of the present disclosure is present or not when the electric pump is in a high RPM driving area.

### DETAILED DESCRIPTION OF THE ILLUSTRATED EMBODIMENTS

Hereinafter, a braking apparatus for a vehicle according to an embodiment of the present disclosure will be described with reference to the accompanying drawings. In this process, the thicknesses of lines or the sizes of components illustrated in the drawings may have been exaggerated for the clarity of a description and for convenience' sake. Terms to be described below have been defined by taking into consideration their functions in the present disclosure, and may be changed depending on a user or operator's intention or practice. Accordingly, such terms should be defined based on the overall contents of this specification.

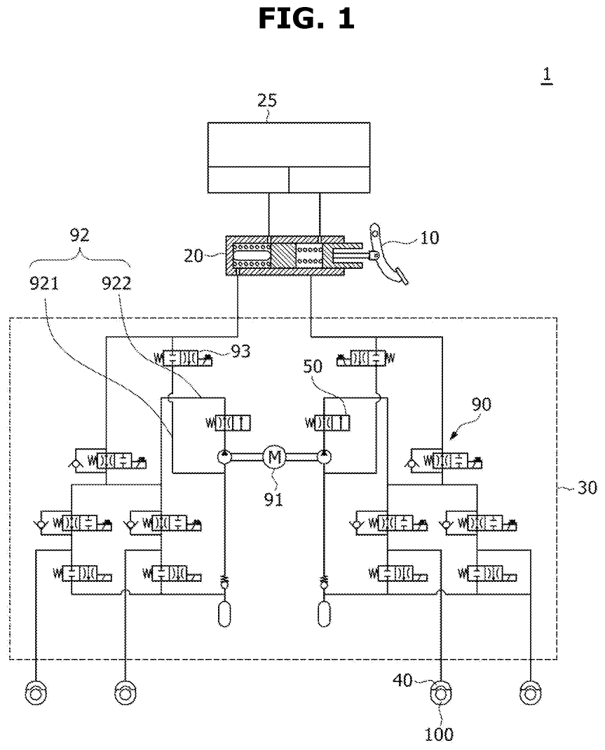

FIG. 1 is a diagram schematically illustrating a braking apparatus for a vehicle according to an embodiment of the present disclosure. Referring to FIG. 1, a braking apparatus 1 for a vehicle according to an embodiment of the present disclosure includes a pedal part 10, a master cylinder part 20, a block part 30, a wheel cylinder part 40, and a variable valve part 50.

The pedal part 10 may be pressurized for braking by a driver. For example, the pedal part 10 may be disposed within a vehicle body. A driver may step on the pedal part 10 while driving.

The master cylinder part 20 may amplify the pressure of oil by the pedal part 10. For example, the master cylinder part 20 may amplify the pressure of oil stored therein as a cylinder in which two chambers have been formed is pressurized while operating in conjunction with the pedal part 10. The master cylinder part 20 may be connected to a storage unit 25 in which oil is stored.

The block part 30 may be connected to the master cylinder part 20 and supplied with oil. As power is applied to the block part 30, an electric pump 91 may amplify the pressure of the oil. For example, the block part 30 may include a hydraulic circuit 90 including a flow channel 92 that induces oil supplied by the master cylinder part 20 to be discharged after being supplied to the electric pump 91 and a valve 93 that opens and closes the flow channel 92.

The wheel cylinder part 40 may be connected to the block part 30, and may provide a braking force to the wheel 100. For example, when oil having high pressure is supplied to the wheel cylinder part 40, a braking force may be generated in the wheel 100.

The variable valve part 50 may be mounted on the block part 30, and may adjust the flow amount of oil depending on a flow rate of the oil that is discharged by the electric pump 91. The variable valve part 50 may permit the passage of the oil only in one direction. The variable valve part 50 may be disposed within the block part 30 so that the variable valve part 50 is not exposed to the outside. That is, the variable valve part 50 may be disposed in the flow channel 92 that is formed within the block part 30. The variable valve part 50 may enable a pulsation reduction because the movement path of oil in the variable valve part 50 is differently designed depending on the amount of oil that passes through the variable valve part 50 by the driving of the electric pump 91. The variable valve part 50 may change a flow channel through which oil passes depending oil the pressure of the oil.

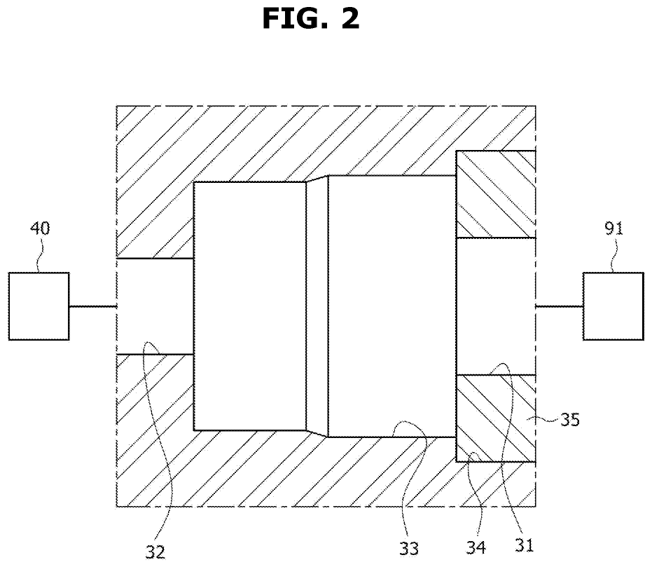

FIG. 2 is a diagram schematically illustrating the block part according to an embodiment of the present disclosure. Referring to FIG. 2, the block part 30 may include a pump flow channel 31, a wheel flow channel 32, and a valve flow channel 33. The flow channel 92 may include a first flow channel 921 and a second flow channel 922. Oil having pressure increased by the master cylinder part 20 may be supplied to the electric pump 91 through the first flow channel 921. Oil that is discharged by the electric pump 91 may be moved to the wheel cylinder part 40 through the second flow channel 922. The pump flow channel 31, the wheel flow channel 32, and the valve flow channel 33 may become a part of the second flow channel 922.

The pump flow channel 31 may provide oil that is discharged by the electric pump 91 with guidance. The pump flow channel 31 may be disposed close to the electric pump 91. The wheel flow channel 32 may be connected to the wheel cylinder part 40. The valve flow channel 33 may connect the pump flow channel 31 and the wheel flow channel 32. A space on which the variable valve part 50 may be mounted may be formed in the valve flow channel 33. The valve flow channel 33 may be disposed between the pump flow channel 31 and the wheel flow channel 32. An inner diameter of the valve flow channel 33 may be designed to be greater than an inner diameter of each of the pump flow channel 31 and the wheel flow channel 32.

An insertion flow channel 34 has been formed so that the variable valve part 50 is inserted into the valve flow channel 33. A valve support part 35 that is mounted on the insertion flow channel 34 may support the variable valve part 50. A hole may be formed at a central part of the valve support part 35. The hole may become the pump flow channel 31.

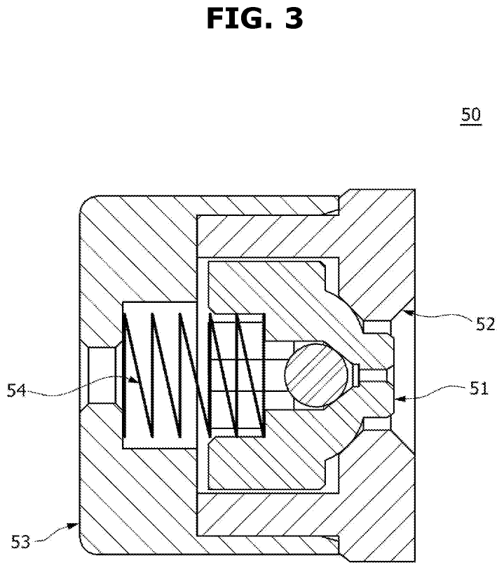

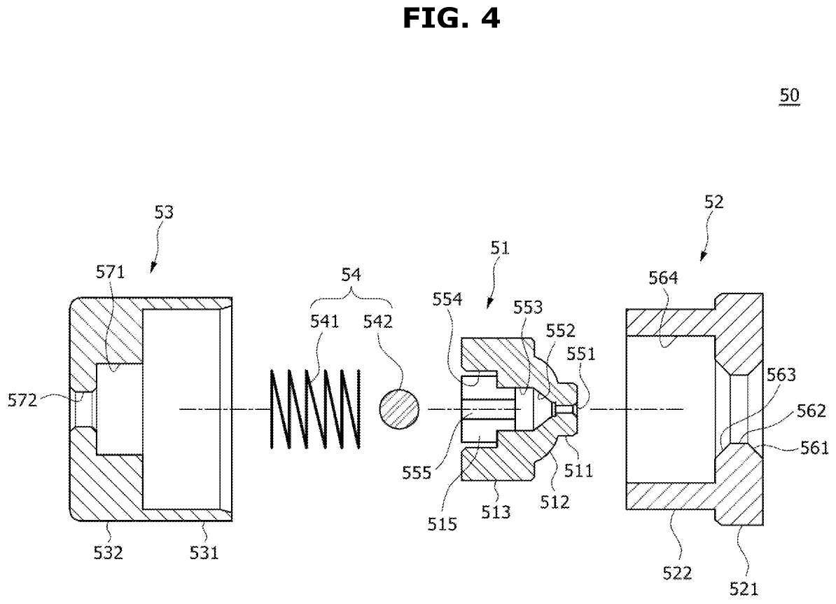

FIG. 3 is a combined cross-sectional view schematically illustrating the variable valve part according to an embodiment of the present disclosure. FIG. 4 is an exploded cross-sectional view schematically illustrating the variable valve part according to an embodiment of the present disclosure. Referring to FIGS. 3 and 4, the variable valve part 50 according to an embodiment of the present disclosure may include an internal valve part 51, an external valve part 52, a cover valve part 53, and an adjustment valve part 54.

The internal valve part 51 may transmit oil through a central part thereof. The central part of the internal valve part 51 may be opened and closed by pressure of the adjustment valve part 54 and the wheel flow channel 32. A hole may be formed at the central part of the internal valve part 51 so that a small amount of oil passes through the hole.

The external valve part 52 may surround the internal valve part 51, and may transmit oil through the inside thereof. An outer diameter of the external valve part 52 may be designed to be greater than an outer diameter of the internal valve part 51. When pressure of oil that is supplied from the pump flow channel 31 rises, the internal valve part 51 that is supported by the adjustment valve part 54 may be moved, so oil may pass between the internal valve part 51 and the external valve part 52.

The cover valve part 53 may be combined with the external valve part 52, and may transmit oil. The cover valve part 53 may constrain the internal valve part 51 embedded in the external valve part 52 by covering an end of the external valve part 52.

The adjustment valve part 54 may be disposed between the internal valve part 51 and the cover valve part 53, and may adjust the movement path of oil by supporting the internal valve part 51. The adjustment valve part 54 may induce the internal valve part 51 to be closely attached to the external valve part 52 by elastically supporting the internal valve part 51. In addition, the adjustment valve part 54 may block the countercurrent of oil while moving along the pressure of the oil in the internal valve part 51.

The internal valve part 51 according to an embodiment of the present disclosure may include an internal inlet part 511, an internal open and close part 512, and an internal expansion part 513.

The internal inlet part 511 may be disposed within the external valve part 52, and may transmit oil that is discharged by the electric pump 91. A first internal hole 551 through which oil passes may be formed at a central part of the internal inlet part 511. An outer circumferential surface of the internal inlet part 511 may be isolated from the external valve part 52.

The internal open and close part 512 may be extended from the internal inlet part 511, may transmit oil, and may block a movement of oil between the internal valve part 51 and the external valve part 52 when the outside of the internal open and close part 512 comes into contact with the external valve part 52. The internal open and close part 512 may be extended toward the wheel flow channel 32. An outer diameter of the internal open and close part 512 may be greater than that of the internal inlet part 511. The outside of the internal open and close part 512 may have a curved shape. A second internal hole 552 that communicates with the first internal hole 551 and that has an inner diameter expanded toward the wheel flow channel 32 may be formed within the internal open and close part 512. An incline may be formed in the second internal hole 552 in a cross section thereof.

The internal expansion part 513 may be extended from the internal open and close part 512, and may transmit oil. An outer diameter of the internal expansion part 513 may be designed to be smaller than an inner diameter of the internal open and close part 512, so that oil can pass between the internal expansion part 513 and the internal open and close part 512. The internal expansion part 513 may include a third internal hole 553 that communicates with the second internal hole 552 and a fourth internal hole 554 that communicates with the third internal hole 553 and that has a greater inner diameter than the third internal hole 553 therein. A step may be formed due to a difference between the inner diameters of the third internal hole 553 and the fourth internal hole 554. A fifth internal hole 555 that induces oil to move toward the wheel flow channel 32 may be formed within the third internal hole 553 and the fourth internal hole 554. The fifth internal hole 555 may have a form in which a plurality of grooves has been isolated from each other on an inner circumferential surface of the internal expansion part 513 in a circumferential direction thereof. The fifth internal hole 555 may be formed in the internal insertion part 515 that is inserted into the fourth internal hole 554.

The external valve part 52 according to an embodiment of the present disclosure may include an outside support part 521 and an outside duct part 522.

The outside support part 521 may be isolated from the internal inlet part 511, and may be closely attached to the internal open and close part 512. The outside support part 521 may include a first outside hole 561, a second outside hole 562, and a third outside hole 563. The first outside hole 561 may provide oil that is supplied from the pump flow channel 31 with guidance. An inner diameter of the first outside hole 561 may be reduced toward the wheel flow channel 32. The second outside hole 562 may communicate with the first outside hole 561, and may have an inner diameter greater than the outer diameter of the internal inlet part 511. The third outside hole 563 may communicate with the second outside hole 562. An inner diameter of the third outside hole 563 may be reduced toward the wheel flow channel 32. When the internal open and close part 512 is closely attached to the third outside hole 563, oil may move through the first internal hole 551.

The outside duct part 522 may be extended from the outside support part 521, may surround the internal expansion part 513, and may provide oil that passes between the outside support part 521 and the internal open and close part 512 with guidance. A fourth outside hole 564 may be formed in the outside duct part 522. An inner diameter of the outside duct part 522 may be greater than the outer diameter of the internal expansion part 513, so that oil may pass between the outside duct part 522 and the internal expansion part 513.

The cover valve part 53 according to an embodiment of the present disclosure may include a cover coupling part 531 and a cover extension part 532.

The cover coupling part 531 may be combined with the outside duct part 522. The cover coupling part 531 may be formed to surround an outer circumferential surface of the outside duct part 522. The cover coupling part 531 may be combined with the outside duct part 522 by a screw or may be assembled with the outside duct part 522 by a hook. In addition, the cover coupling part 531 and the outside duct part 522 may be combined in various ways.

The cover extension part 532 may be extended from the cover coupling part 531, and may transmit oil. The cover extension part 532 may include a first cover hole 571 and a second cover hole 572. The first cover hole 571 may communicate with the fourth internal hole 554. The diameter of the first cover hole 571 may be designed to be greater than the diameter of the fourth internal hole 554, and may be designed to be smaller than the diameter of the fourth outside hole 564. The second cover hole 572 may communicate with the first cover hole 571, and may discharge oil that has passed through the first cover hole 571 to the wheel flow channel 32. The second cover hole 572 may be formed to have a smaller diameter than the first cover hole 571, so that a step may be formed at a boundary point between the second cover hole 572 and the first cover hole 571.

The adjustment valve part 54 according to an embodiment of the present disclosure may include an adjustment elastic part 541. The adjustment elastic part 541 may be disposed between the cover extension part 532 and the internal expansion part 513, and may elastically support the internal expansion part 513. The adjustment elastic part 541 may have a coil spring shape. The adjustment elastic part 541 may be inserted into the first cover hole 571 and the fourth internal hole 554. The adjustment elastic part 541 may elastically support the internal expansion part 513. The adjustment elastic part 541 may be formed to surround the internal insertion part 515.

The adjustment valve part 54 according to an embodiment of the present disclosure may further include an adjustment ball part 542. The adjustment ball part 542 may open and close a flow channel of oil by being moved by the pressure of the oil within the internal open and close part 512. The adjustment ball part 542 may be moved between the second internal hole 552 and the third internal hole 553. The adjustment ball part 542 may come into contact with the inner circumferential surface of the internal open and close part 512, which forms the second internal hole 552, and can prevent the countercurrent of oil. The adjustment ball part 542 may be moved by the pressure of oil that is supplied through the pump flow channel 31, and may be supported by the adjustment elastic part 541 or the internal insertion part 515. When the adjustment ball part 542 is supported by the adjustment elastic part 541 or the internal insertion part 515, the oil may be moved through the fifth internal hole 555.

A pulsation phenomenon can be reduced because one or more variable valve parts 50 each including the internal valve part 51, the external valve part 52, the cover valve part 53, and the adjustment valve part 54 are formed in a flow channel that is formed in the braking apparatus 1 for a vehicle and that provides oil with guidance. In this case, detailed constructions of the internal valve part 51, the external valve part 52, the cover valve part 53, and the adjustment valve part 54 are identical with those described with reference to FIGS. 3 and 4, and thus detailed descriptions thereof are omitted.

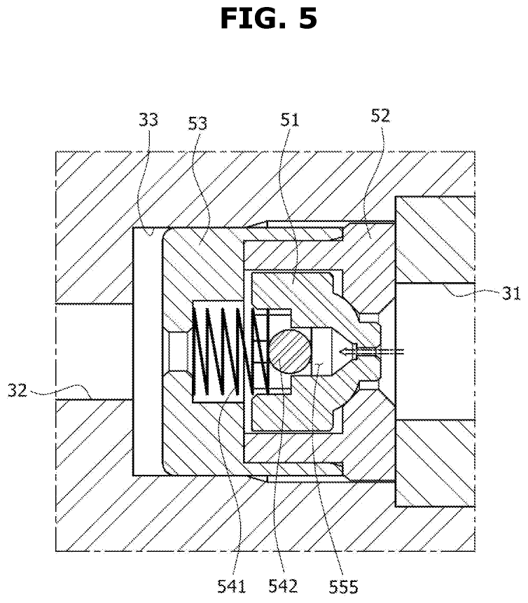

FIG. 5 is a diagram schematically illustrating the state in which a small amount of oil passes through the variable valve part according to an embodiment of the present disclosure. Referring to FIG. 5, in a low RPM driving area of the electric pump 91, the pressure of oil that has entered the pump flow channel 31 is smaller than a restoring force of the adjustment elastic part 541 that elastically supports the internal valve part 51. In this case, an external surface of the internal open and close part 512 is closely attached to the outside support part 521. Accordingly, the oil that has been introduced into the first internal hole 551 may push the adjustment ball part 542, may pass through the fifth internal hole 555, and may then pass through the cover valve part 53 and enter the wheel flow channel 32.

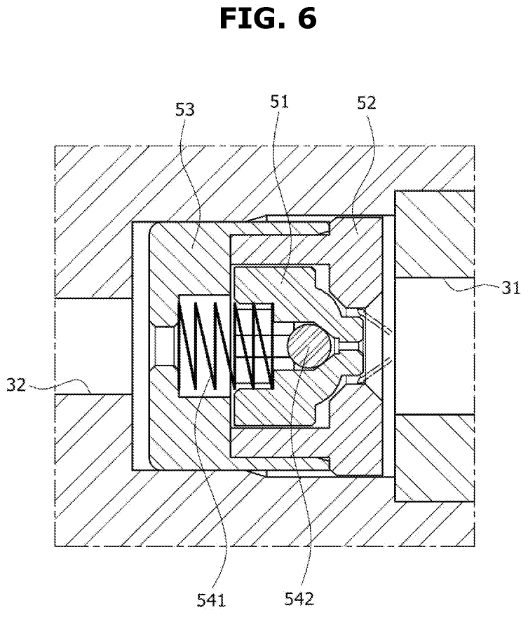

FIG. 6 is a diagram schematically illustrating the state in which a large amount of oil passes through the variable valve part according to an embodiment of the present disclosure. Referring to FIG. 6, in a high RPM driving area of the electric pump 91, the pressure of oil that has entered the pump flow channel 31 is greater than the restoring force of the adjustment elastic part 541 that elastically supports the internal valve part 51. Accordingly, as the adjustment elastic part 541 is contracted, the external surface of the internal open and close part 512 is isolated from the outside support part 521. Furthermore, the oil may pass between the internal valve part 51 and the external valve part 52, and may then pass through the cover valve part 53 and enter the wheel flow channel 32. In this case, some of the oil may push the adjustment ball part 542, may pass through the fifth internal hole 555, and may then pass through the cover valve part 53 and enter the wheel flow channel 32.

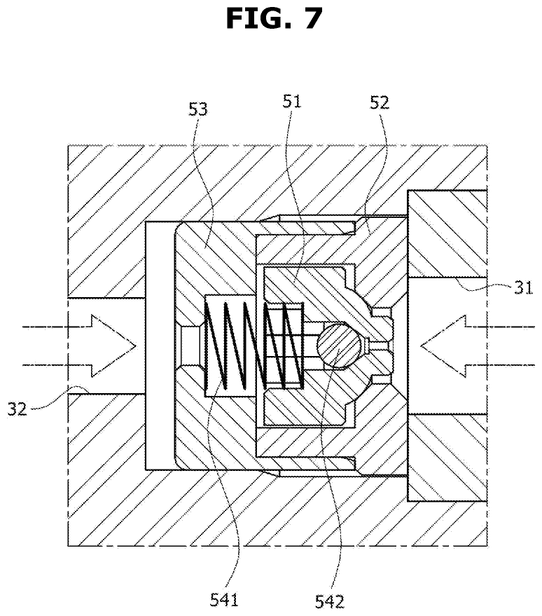

FIG. 7 is a diagram schematically illustrating the state in which the countercurrent of oil through the variable valve part according to an embodiment of the present disclosure is prevented. Referring to FIG. 7, when an operation of the electric pump 91 is stopped, the adjustment ball part 542 is closely attached to an inner wall of the internal open and close part 512 by the pressure of oil from the wheel flow channel 32. Accordingly, the countercurrent of oil can be prevented because the first internal hole 551 is closed.

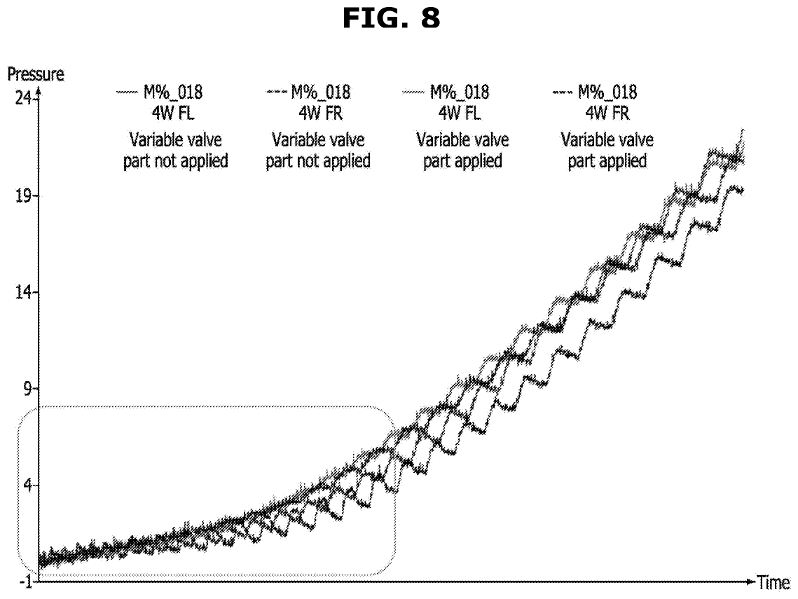

FIG. 8 is a graph schematically illustrating a pressure change depending on whether the variable valve part according to an embodiment of the present disclosure is present or not when the electric pump is in a low RPM driving area. Referring to FIG. 8, a reduction of pressure amplitude of less than 10 bar was checked if the variable valve part 50 was applied.

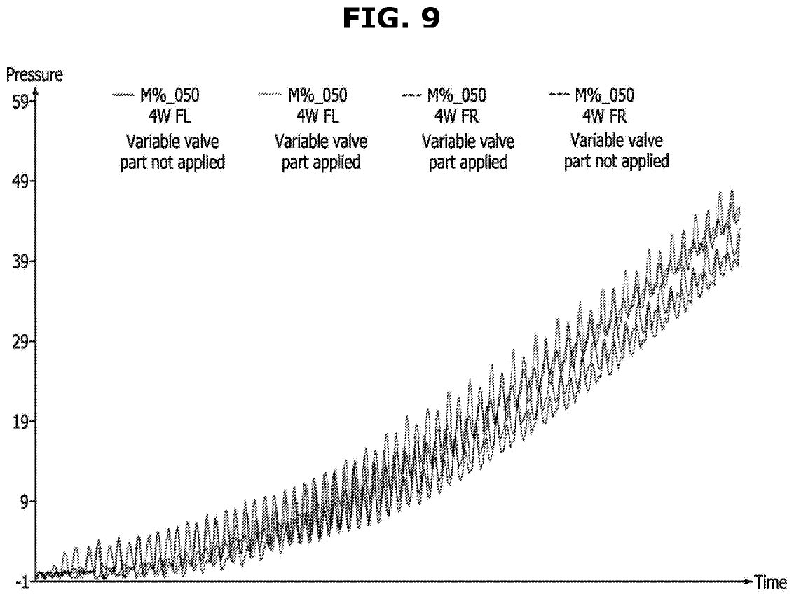

FIG. 9 is a graph schematically illustrating a pressure change depending on whether the variable valve part according to an embodiment of the present disclosure is present or not when the electric pump is in a high RPM driving area. Referring to FIG. 9, an increased pressure reduction effect is insignificant in the state in which the variable valve part 50 was applied and the state in which the variable valve part 50 was not applied.

As illustrated in FIGS. 8 and 9, the braking apparatus 1 for a vehicle according to an embodiment of the present disclosure can reduce pulsation amplitude and prevent a loss of increased pressure performance because the variable valve part 50 is applied and a movement path of oil is changed as a small amount of oil or a large amount of oil passes through the variable valve part 50.

Although embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A braking apparatus for a vehicle, the braking apparatus comprising:
a pedal part;
a master cylinder part engaged to the pedal part and in which pressure of oil is amplified by the pedal part;
a block part connected to the master cylinder part, supplied with the oil, and configured to amplify the pressure of the oil as an electric pump is driven by power applied thereto;
a wheel cylinder part connected to the block part and configured to provide a braking force to a wheel of the vehicle; and
a variable valve part mounted on the block part and configured to adjust an flow amount of oil based on a flow rate of the oil that is discharged by the electric pump.

2. The braking apparatus of claim 1, wherein the block part includes:
a pump flow channel configured to provide the oil that is discharged by the electric pump with guidance;
a wheel flow channel connected to the wheel cylinder part; and
a valve flow channel configured to connect the pump flow channel and the wheel flow channel, wherein the variable valve part is mounted on the valve flow channel.

3. The braking apparatus of claim 1, wherein the variable valve part includes:
an internal valve part configured to transmit oil through a first hole formed at a central part of the internal valve part;
an external valve part surrounding the internal valve part and to transmit oil toward an inside thereof through a second hole formed at a central part of the external valve part, wherein the internal valve part is slidably mounted in the external valve part;
a cover valve part coupled to the external valve part and configured to transmit oil through a third hole formed in the cover valve part; and
an adjustment valve part mounted between the internal valve part and the cover valve part and configured to adjust a flow passage of oil by elastically supporting the internal valve part.

4. The braking apparatus of claim 3, wherein the internal valve part includes:
an internal inlet part including the first hole and disposed within the second hole of the external valve part and configured to transmit the oil discharged by the electric pump through the first hole;
an internal open and close part extended from the internal inlet part and including an internal hole connected to the first hole, and configured to transmit oil between the internal valve part and the external valve when an outside of the internal open and close part does not come into contact with the external valve part or to block a movement of oil between the internal valve part and the external valve part when the outside of the internal open and close part comes into contact with the external valve part; and
an internal expansion part extended from the internal open and close part and configured to transmit oil through the internal hole of the internal expansion part.

5. The braking apparatus of claim 4, wherein the external valve part includes:
an outside support part including the second hole and spaced from the internal inlet part, and configured to selectively contact to the internal open and close part; and
an outside duct part extended from the outside support part and surrounding the internal expansion part, wherein a flow passage of the oil is formed between the second hole of the outside support part and the first hole of the internal open and close part.

6. The braking apparatus of claim 5, wherein the cover valve part includes:
a cover coupling part connected to the outside duct part; and
a cover extension part extended from the cover coupling part and including the third hole through which the oil is transmitted.

7. The braking apparatus of claim 6, wherein the adjustment valve part includes an adjustment elastic part disposed between the cover extension part and the internal expansion part and configured to elastically support the internal expansion part toward the internal valve part.

8. The braking apparatus of claim 7, wherein the adjustment valve part further includes an adjustment ball part mounted between the internal valve part and the cover valve part and configured to open or close a flow channel of oil between the first hole of the internal valve part and the third hole of the cover valve part by being moved by pressure of the oil within the internal open and close part.

9. The braking apparatus of claim 8, wherein the adjustment ball part is mounted adjacent to the internal hole that is formed within the internal open and close part, and selectively closes the internal hole to prevent a countercurrent of the oil.

10. A braking apparatus for a vehicle, the braking apparatus comprising:
an internal valve part configured to transmit oil through a first hole formed at a central part of the internal valve part;
an external valve part surrounding the internal valve part and to transmit oil toward an inside thereof through a second hole formed at a central part of the external valve part, wherein the internal valve part is slidably mounted in the external valve part;
a cover valve part coupled to the external valve part and configured to transmit oil through a third hole formed in the cover valve part; and
an adjustment valve part mounted between the internal valve part and the cover valve part and configured to adjust a passage of oil by elastically supporting the internal valve part.

11. The braking apparatus of claim 10, wherein the internal valve part includes:
an internal inlet part including the first hole and disposed within the second hole of the external valve part and configured to transmit the oil through the first hole;
an internal open and close part extended from the internal inlet part and including an internal hole connected to the first hole, and configured to transmit oil between the internal valve part and the external valve when an outside of the internal open and close part does not come into contact with the external valve part or to block a movement of oil between the internal valve part and the external valve part when the outside of the internal open and close part comes into contact with the external valve part; and
an internal expansion part extended from the internal open and close part and configured to transmit oil through the internal hole of the internal expansion part.

12. The braking apparatus of claim 11, wherein the external valve part includes:
an outside support part including the second hole and spaced from the internal inlet part, and configured to selectively contact to the internal open and close part; and
an outside duct part extended from the outside support part and surrounding the internal expansion part, wherein a flow passage of the oil is formed between the second hole of the outside support part and the first hole of the internal open and close part.

13. The braking apparatus of claim 12, wherein the cover valve part includes:
a cover coupling part connected to the outside duct part; and
a cover extension part extended from the cover coupling part and including the third hole through which the oil is transmitted.

14. The braking apparatus of claim 13, wherein the adjustment valve part includes an adjustment elastic part disposed between the cover extension part and the internal expansion part and configured to elastically support the internal expansion part toward the internal valve part.

15. The braking apparatus of claim 14, wherein the adjustment valve part further includes an adjustment ball part mounted between the internal valve part and the cover valve part and configured to open or close a flow channel of oil between the first hole of the internal valve part and the third hole of the cover valve part by being moved by pressure of the oil within the internal open and close part.

16. The braking apparatus of claim 15, wherein the adjustment ball part is mounted adjacent to the internal hole that is formed within the internal open and close part, and selectively closes the internal hole to prevent a countercurrent of the oil.
